(19) United States
(12) Patent Application Publication
(10) Pub. No.: US 2012/0038997 A1
(43) Pub. Date: Feb. 16, 2012

(54) SYSTEM FOR WRITE FAULT PROTECTION IN A HARD DISK DRIVE

(75) Inventor: Qing Wei Jia, Singapore (SG)

(73) Assignee: Hitachi Asia Ltd., Singapore (SG)

(21) Appl. No.: 12/857,180

(22) Filed: Aug. 16, 2010

(51) Int. Cl. G11B 27/36

(52) U.S. Cl. 360/31; G9B/27.052

(57) ABSTRACT

This invention relates to a system and method performed by a controller in a hard disc drive to generate a write fault signal. The system performs in the following manner. The system begins by receiving a sample of a position error signal. The system then generates a control signal from the position error signal. A sample of the control signal is then captured by the system. The system then determines a parameter to test from the captured sample of the control signal. The absolute value of the parameter is then calculated and compared to a threshold value. The system then generates a write fault error signal in response to a determination that the absolute value of the parameter is greater than or equal to the threshold value.

### FIELD OF THE INVENTION

This invention relates to a controller for a hard disk drive. More particularly, this invention relates to a system for write fault protection in a controller of a hard disk drive. Still more particularly, this invention relates to generating write fault signal based upon a comparison of a control signal generated by the controller to a threshold value.

### SUMMARY OF THE PRIOR ART

Hard Disk Drives (HDD)s are commonly used as a memory device in a wide variety of electronic devices. As the devices become smaller in size, the size of the HDD must also decrease for incorporation into the devices. As the size of HDDs decrease and to increase the amount of memory provided, the data track width and data bit width become narrower to increase the Track Per Inch (TPI) on the disk. As the width becomes narrow, the operation of the HDD becomes more susceptible to shock and rotary vibration.

One particular operation of an HDD that is affected by these outside forces is a write operation. Shocks or outside forces can cause a misalignment of the write head with a track causing data corruption during a write operation commonly referred to as a write fault. A wrongly positioned head may overwrite data in an adjacent track corrupting the data currently stored in the track and/or the writing the data to an unintended address making the data irretrievable.

One common method for preventing write faults is to include a shock sensor in the HDD. A shock sensor detects acceleration in certain directions and outputs a signal that is proportional to the acceleration. This may be used to as alert signal and/or to correct the control signal applied to an actuator in the HDD. However, shock sensors require additional circuitry adding to the cost of the HDD. This can be problematic especially in lower-end HDDs.

A second common method for preventing write faults is the use of off-track thresholds which may also be referred to as write fault gates. A Position Error Signal (PES) is compared to a threshold to determine whether there is an off-track error. To improve this method, a second comparison may be made in which an estimated next PES is compared to a second threshold in an attempt to detect the write fault prior to applying the control signal. However, it is a problem that as the technology advances, these methods may not detect write fault quickly enough to prevent a write fault. This problem arises because servo sector numbers may not grow as quickly as TPI increases due to limitation in drive format efficiency and microprocessor bandwidth.

Thus, those skilled in the art are constantly trying to find a cheap and reliable way to provide a write fault detection system that improves write fault detection without affecting throughput performance of the HDD at low shock levels.

### SUMMARY OF THE INVENTION

The above and other problems are solved and an advance in the art is made by a system for write fault protection in accordance with this invention. A first advantage of a system in accordance with this invention is that write fault detection is improved which, in turn, improves data integrity performance of HDD products. A second advantage is that throughput performance is not significantly affected. A third advantage is that a system in accordance with this invention does not require additional circuitry which reduces the cost. This makes a system in accordance with this invention suitable for incorporation into low end HDD products.

In accordance with embodiments of this invention, a system for determining a write fault in a hard disk drive includes circuitry and/or software for performing the following process. The system begins by receiving a sample of a position error signal. A controller then generates a control signal from the position error signal. A sample of the control signal is then captured by the system. The system then determines a parameter to test from the captured sample of the control signal. The absolute value of the parameter is then calculated. The absolute value of the parameter is then compared to a threshold value. The system then generates a write fault error signal in response to a determination that the absolute value of the parameter is greater than or equal to the threshold value.

In accordance with some embodiments, the parameter is the control signal. In accordance with other embodiments, the parameter is the variation of the control signal that may be determined by determining the difference of the current sample of the control signal from a previous sample of the control signal read from memory. The current sample may then be stored as the previous sample of the control signal for use in a subsequent determination of the variation. In accordance with these embodiments, the threshold values should be selected so as to improve write protection performance and not degrade throughput performance.

In accordance with some embodiments of this invention, the system may also determine an absolute value of the received position error signal and compare the absolute value of the position error signal to a second threshold. A write fault signal is then generated in response to a determination that the absolute value of the position error signal is greater than or equal to the second threshold.

In accordance with further embodiments, the system may calculate an estimated next position error signal from the sample of the position error signal. An absolute value of the estimated next position error signal is determined and compared with a third threshold. A write fault error is then generated in response to a determination that the absolute value of the estimated next position error signal is greater than or equal to the third threshold. In accordance with some of these embodiments, the estimated next position error signal is determined from the sample of the position error signal and an average acceleration of the position error signal. In accordance with particular ones of these embodiments, the estimated next position error signal is generated from a determined velocity and acceleration of the position error signal. In other ones of these embodiments, the next position error signal is determined from the received position error signal sample, a first previous position error signal, and a second previous position error signal sample using the following equation:

x̅(k+1)=5/2x(k)−2x(k−1)+1/2x(k−2)

where x̅(k+1) is the estimated next position error signal, x(k) is the received sample of the position error signal, x(k−1) is the sample of the first previous position error signal, and x(k−2) is the sample of the second previous position error signal.

### BRIEF DESCRIPTION OF THE DRAWINGS

The above and other advantages and features of the present invention are described in the following detailed description and are shown in the following drawings:

FIG. 1 illustrates the components of a hard disk drive including a system for write fault detection in accordance with an embodiment of this invention;

FIG. 2 illustrating a block diagram of components of a servo-loop for a hard disk drive in accordance with an embodiment of this invention;

FIG. 3 illustrating a graph showing a correlation between control signals disturbances;

FIG. 4 illustrating a graph of off-track position versus shock disturbances of a prior art system and an embodiment of this invention;

FIG. 5 illustrating a graph of a throughput performance of a prior art system and a system in accordance with an embodiment of this invention;

FIG. 6 illustrating a flow diagram of a process performed by the system in accordance with this invention.

### DETAILED DESCRIPTION

This invention relates to a controller for a hard disk drive. More particularly, this invention relates to a system for write fault protection in a controller of a hard disk drive. Still more particularly, this invention relates to generating write fault signal based upon a comparison of a control signal generated by the controller to a threshold value.

This invention is a system that performs a process for generating a write fault error signal in response to detection of a write fault. The process may be performed by instructions executed by a processing unit, such a digital signal processor, circuitry or a combination of the two without departing from this invention.

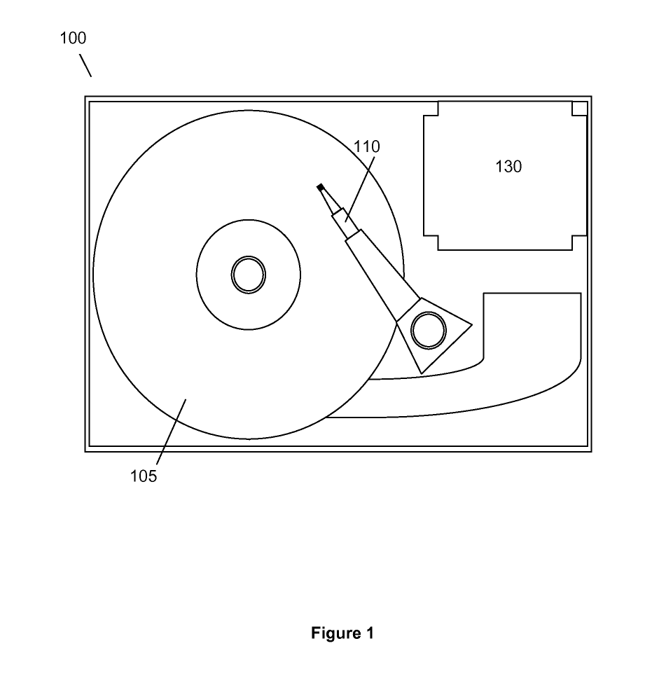

FIG. 1 illustrates hard disk drive 100 in accordance with this invention. Hard disk drive includes a disk 105 that is rotated by a spinning motor (Not Shown). Read and write heads are connected to a slider at the end of actuator arm 110. Actuator arm 110 moves the slider back and forth over the rotating disk to position the read and write heads over the proper track of the disk to perform a read or write operation. Control circuitry 130 is all of the circuitry that controls the operations of disk drive 100. Control circuitry 130 preferably includes a digital signal processor, voice coil motor, and other circuitry needed to perform the various operations of hard disk drive 100. The exact configuration control circuitry 130 is unimportant to the present invention and is omitted for brevity.

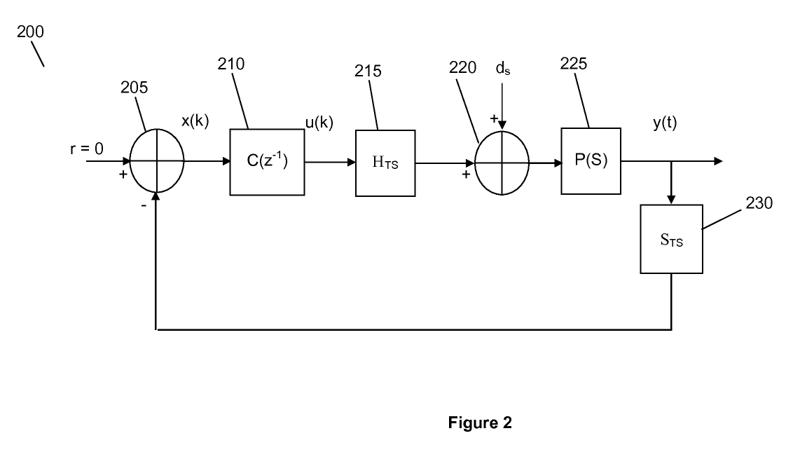

FIG. 2 illustrates servo control loop 200 that generates a control signal that controls the movement of actuator. One skilled in the art will recognize that servo control loop 200 is implemented by a digital signal processor executing instructions and/or hardware circuits in control circuitry 130 of FIG. 1. However, the exact configuration is not important in accordance with this invention and only those components of servo control loop 200 that are need to understand the invention are shown and described.

Servo control loop 200 includes mixer 205 that receives the signal output to the plant and a system signal. Mixer 205 mixes the received signals to produce a Position Error Signal (PES). Controller 210 receives the PES error signal from mixer 205 and generates a new digital control signal, u(k), to apply to the plant. Zero order hold 215 receives the digital control signal generated by controller 210 and holds for a period. Mixer 220 is not an actual part of the system but is included to show disturbance signals caused by shocks and other outside factors being added to the control signal. The control signal is then receive by plant 225 and converted to output signal, y(t). Sampler 230 then captures the output signal for future use.

This invention relates to generating a write fault error signal that can be transmitted to a read/write controller to halt execution of a write operation due to detecting track misalignment. In the past, the PES generated by mixer 205 was sampled and compared to a threshold value. The threshold value may be an absolute value of off-track percentage. To improve write fault detection, an estimated next PES may be calculated from the current PES and compared to second threshold value. The second threshold value is also an absolute value of off-track percentage. These may be expressed in the following equations:

x(k)≧c₁;or

x̅(k+1)≧c₂

where x(k) is the sample of the PES at time k, c₁ is the first threshold, x̅(k+1) is the estimated next sample of the PES at time k+1. However, one problem using these equations is that the estimate of the next sample of the PES is often inaccurate. One way to improve the estimate of the PES at the next sample period is to consider the head acceleration in the determination. In the prior art, the estimated PES for the next signal is typically estimated using the head velocity. The head velocity is easily determined using the current and previous PES. Thus, head velocity, v(k), equals the previous PES, x(k−1), subtracted from the current PES, x(k) which may be written as: v(k)=x(k)−x(k−1)
The estimation of the PES at the next sample period is simply the adding of the velocity to the current position signal. Hence, the estimated PES at the next sample period may be expressed as:

x̅(k+1)=x(k)+v(k)=2x(k)−x(k−1)

Note that acceleration of the head is not considered in this equation. The estimation using only velocity to determine the next estimated PES may not be accurate. This is because the acceleration of the head may change abruptly when a hard disk drive is subject to shock/vibration disturbances.

Therefore, in accordance with some embodiments of the invention, the calculation of the estimate of the PES at the next sample period is determined using an average acceleration. As is known acceleration, a(k), equals the difference of the current velocity, v(k), and the previous velocity, v(k−1). Thus acceleration may be expressed in terms of the PES in the following manner:

$$\begin{matrix}a ( k ) = v ( k ) - v ( k - 1 ) \\ = x ( k ) - x ( k - 1 ) - [ x ( k - 1 ) - x ( k - 2 ) ] \\ = x ( k ) - 2 x ( k - 1 ) + x ( k - 2 )\end{matrix}$$

Where x(k) is the PES at the current sample period, x(k−1) is the PES at the period immediately prior to the current period, and x(k−2) is the PES at the period two periods prior to the current period.
The estimated PES for the next period may be expressed as follows:

$$\begin{matrix}\overline{x} ( k + 1 ) = x ( k ) + v ( k ) + \frac{1}{2} a ( k ) \\ = \frac{5}{2} x ( k ) - 2 x ( k - 1 ) + \frac{1}{2} x ( k - 2 )\end{matrix}$$

This is a more accurate determination of the estimate of the PES. However, the improvement in write fault detection is still limited by the fact that the average acceleration signal a(k) is at least one sector time delayed. Thus, the write fault error may not be determined quickly enough to be useful. Secondly, the acceleration signal obtained from the PES is very noisy. Thus, a low pass filter may need to be added to the servo loop to obtain a cleaner signal.

The above improves the existing write fault gates used in low end disk drives. However, a system in accordance with the present invention uses a comparison of a parameter derived from the control signal, u(k), generated by the controller to detect a write fault error. This comparison or fault gate may be used as a stand-alone test or in combination with any and/or all of the above described tests to detect write fault errors.

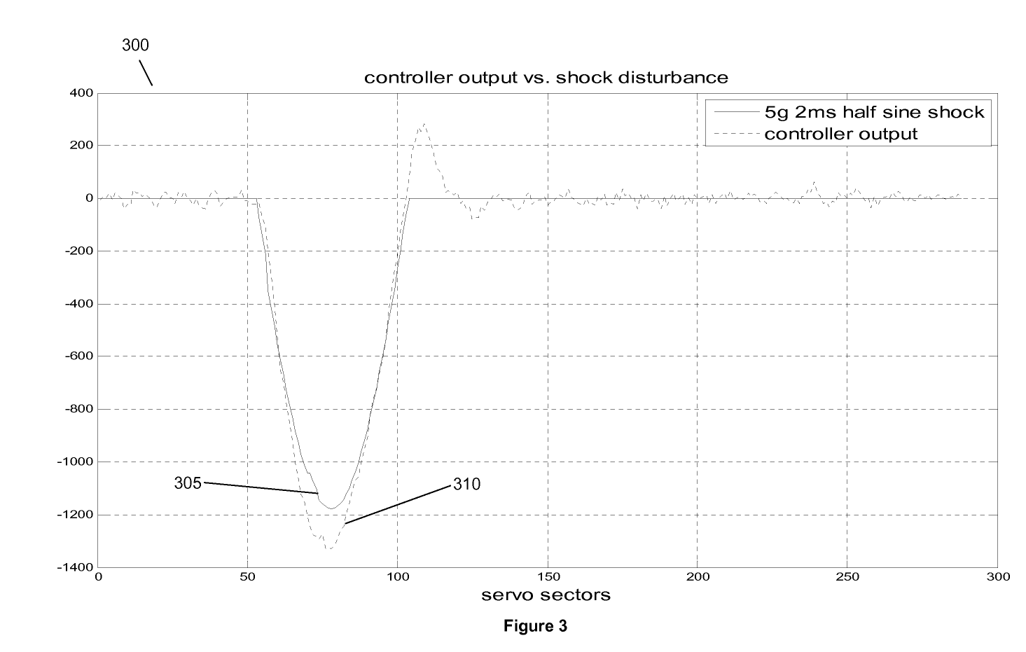

As shown in FIG. 3, the controller output signal may be expressed as u=PC/(1+PC)*dₛ, where P is the plant model, C is the digital controller. Typically, shock signals are of low frequencies, and the gain of (PC/(1+PC)) is almost unity at these low frequencies. This implies that control output signal can be used to detect shock disturbance as is shown in FIG. 3 in which the shock signal is shown by plot 305 and the output control signal is shown by plot 310. Thus it can be seen that the output control signal tracks the disturbance and may be used to detect an unacceptable disturbance. Thus, in accordance with one embodiment of this invention, the absolute value of the output control signal is compared to a threshold value which is expressed in the following terms:

|u(k)|≧c₃

where c₃ is a constant that is selected so as to improve write protection performance and degradation of throughput performance is minimized.

Alternatively, the variation of the controller output signal, u, can be used to detect a write fault. The variation of the control signal over the last sampling period, Δu, can be compared to a constant threshold value. The variation being expressed in terms of the output control signals as:

Δu=u(k)−u(k−1)

where u(k) is the output signal of the current sample period and u(k−1) is the output control signal from the previous sample period. Thus, the comparison to a threshold is:

|Δu|≧c₄

where c₄ is a constant that is selected so as to improve write protection performance and degradation of throughput performance is minimized.

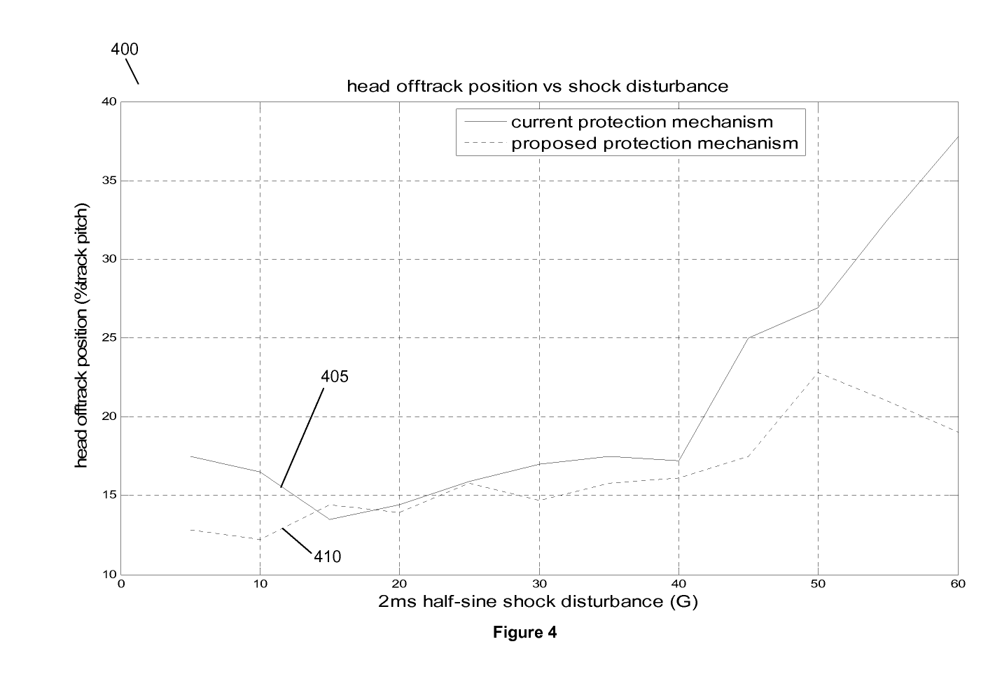

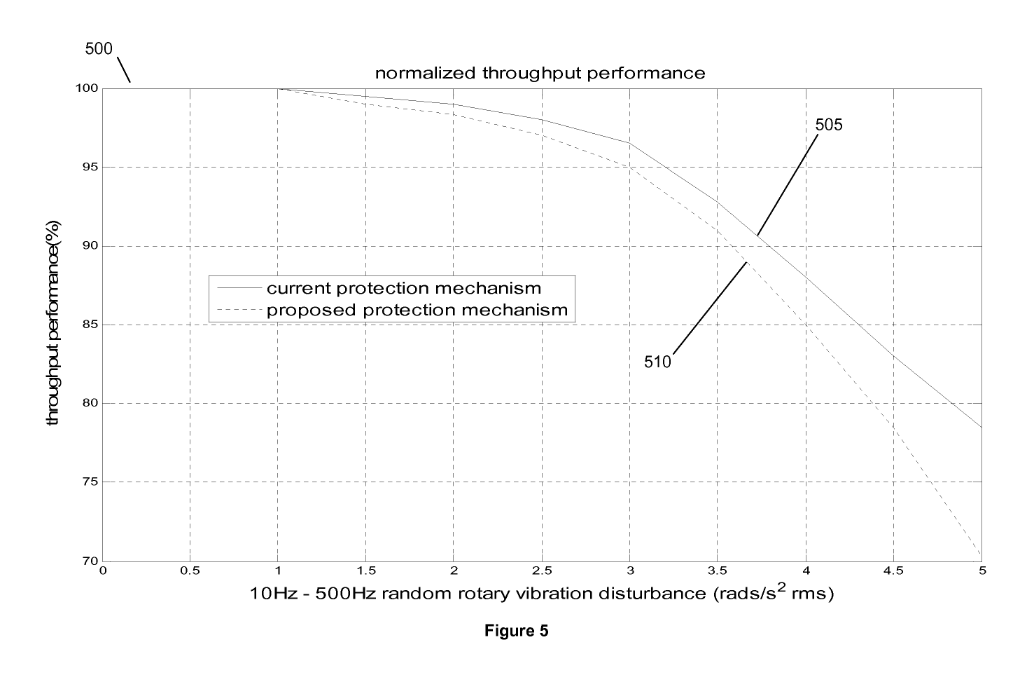

FIGS. 4 and 5 illustrate graphs plotting the performance of a conventional system using comparisons of a prior art write fault protection scheme and one that includes a third test using a parameter based on the output control signal in accordance with this invention. To generate the plots in the graph, 2 ms half sine shock disturbance with different amplitudes are introduced into the servo loop. FIG. 4 shows the off-track positions of the read/write head at moments that a write fault error is detected. Line 405 shows the prior art scheme and line 410 shows the system with the third test using the control signal comparison in accordance with this invention. From FIG. 4, it can be seen that the off-track positions of the read/write head at protection moments are greatly restricted by using the third write fault test or gate. Thus, data integrity is improved in a system in which a third test using the control signal is used.

The throughput performance during a test in which the disk drive is mounted on a rotational shaker system that introduces random noises of 10 Hz to 500 Hz. Line 505 is the plot of a prior art system using the two test of the PES described above and line 510 is a plot of a system in which a test using the control signal in accordance with this invention is used. From FIG. 5, it can be observed that the throughput performance of both systems is almost the same. However, as the disturbance amplitude goes up, the throughput performance of the new system drops more rapidly than the prior art system. This occurs because the new system detects more write fault errors causing more interruptions in the process. Thus, data integrity is better protected by a system incorporating a system in accordance with this invention.

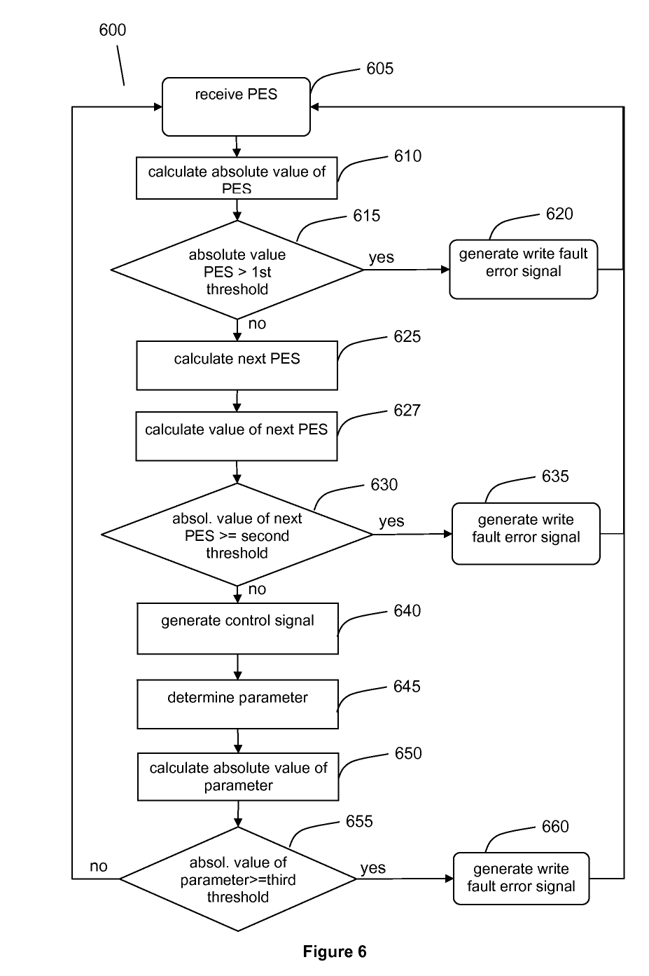

FIG. 6 illustrates a flow diagram of a process performed by a controller to provide write fault protection in accordance with an embodiment of this invention. Process 600 begins in step 605 by receiving a sample of the PES for the current sample period. In step 610, the absolute value of the PES is calculated. In step 615, process 600 determines whether the absolute value of the PES is greater than or equal to a first threshold. If the absolute value of the PES is greater than or equal to the threshold, a write fault error signal is generated in step 620. Otherwise, process 600 continues to step 625.

In step 625, an estimated PES for the next sample period is calculated. As discussed above, the estimated PES is preferably calculated taking the average acceleration into account. In step 627, the absolute value of the estimated PES is calculated. In step 630, if the absolute value of the estimated PES is greater than or equal to the second threshold, a write fault error signal is generated in step 635. Otherwise, process 600 proceeds to step 640.

In step 640, process 600 generates the control signal to be applied to the plant. In step 645, a parameter to compare to a third threshold is determined from the control signal. As discussed above, the parameter may be the control signal, itself, or the change in the control signal, Δu. The absolute value of the parameter is determined in step 650 and compared to the third threshold in step 655. If the absolute value of the parameter is greater than or equal to the third threshold, process 600 generates a write fault error signal in step 660. If the absolute value of the parameter is not greater than or equal to the third threshold or after steps 625, 640, or 655, process 600 repeats from step 605 when a sample is received in the next time period.

The above is a description of embodiments of a system in accordance with the invention as set forth below. It is envisioned that those skilled in the art can and will design alternative embodiments of this invention based upon this invention that infringe on this invention as set forth in the following claims.

What is claimed is:

1. A system for determining a write fault in a hard disk drive comprising:
instructions for directing a processing unit to:
receive a sample of a position error signal,
generate a control signal from said position error signal,
capture a sample of said control signal,
determine parameter from said sample of said control signal,
calculate an absolute value of said parameter,
compare said absolute value of said parameter to a threshold value, and
generate a write fault error signal in response to a determination that said absolute value is greater than or equal to said threshold value; and
a media readable by said processing unit that stores said instructions.

2. The system of claim 1 wherein said instructions to determine said parameter comprise:
instructions directing said processing unit to determine said control signal from said sample.

3. The system of claim 2 wherein said threshold is selected to improve write protection performance and not degrade throughput performance.

4. The system of claim 1 wherein said instructions to determine said parameter comprise:
instructions for directing said processing unit to determine a variation of said control signal from said sample of said control signal.

5. The system of claim 1 wherein said instructions to determine said variation comprise:
instructions for directing said processing unit to:
read a previous sample of said control signal from a memory, and
calculate a difference of said sample of said previous control signal from said sample of said control signal.

6. The system of claim 5 wherein said instructions to determine said variation comprise:
instructions for directing said processing unit to store said sample of said control signal as said previous control signal in said memory for use in a subsequent determination of said variation.

7. The system of claim 1 wherein said instructions further comprise:
instructions for directing said processing unit to:
determine an absolute value of said sample of said position error signal,
compare said absolute value of said sample of said position error signal with a second threshold, and
generate said write fault error in response to a determination that said absolute value of said sample of said position error signal is greater than or equal to said second threshold.

8. The system of claim 7 wherein said instructions further comprise:
instructions for directing said processing unit to:
calculate an estimated next position error signal from said sample of said position error signal;
determine an absolute value of said next position error signal,
compare said absolute value of said next position error signal with a third threshold, and
generate said write fault error in response to a determination that said absolute value of said next position error signal is greater than or equal to said third threshold.

9. The system of claim 8 wherein said instructions for calculating said next position error signal comprises:
instructions for directing said processing unit to:
determine said next position error signal from said sample of said position error signal and an average acceleration of said position error signal.

10. The system of claim 9 wherein said instructions to determine said next position error signal from said sample of said position error signal and an average acceleration of said position error signal comprise:
instructions for directing said processing unit to:
determine a velocity of said position error signal;
determine an average acceleration of said position error signal,
calculate said next position error signal in accordance with the following equation
x̅(k+1)=x(k)+v(k)+1/2a(k)
where x̅(k+1) is the estimate next position error signal, x(k) is said position error signal, v(k) is said velocity, and a(k) is said average acceleration.

11. The system of claim 9 wherein said instructions to determine said next position error signal from said sample of said position error signal and an average acceleration of said position error signal comprise:
instructions for directing said processing unit to:
read a sample of a previous position error signal from memory,
read a sample of a second previous position error signal from said memory, and
calculate said estimated next position error signal from the following equation:
x̅(k+1)=5/2x(k)−2x(k−1)+1/2x(k−2)
where x̅(k+1) is said estimated next position error signal, x(k) is said sample of a previous position error signal, x(k−1) is said sample of a previous position error signal, and x(k−2) is said sample of a second previous position error signal.

12. The system of claim 8 wherein said instructions further comprise:
instructions for directing said processing unit to:
generate said write fault signal in response to one selected from a group consisting of said absolute value of said parameter being greater than or equal to said first threshold, said absolute value of said sample of said position error signal being greater than or equal to said second threshold, and said absolute value of said estimated next position error signal being greater than or equal to said third threshold.

13. The system of claim 8 wherein said instructions further comprise:
instructions for directing said processing unit to:
generate said write fault signal in response to two selected from a group consisting of said absolute value of said parameter being greater than or equal to said first threshold, said absolute value of said sample of said position error signal being greater than or equal to said second threshold, and said absolute value of said estimated next position error signal being greater than or equal to said third threshold.

14. The system of claim 8 wherein said instructions further comprise:
instructions for directing said processing unit to:
generate said write fault signal in response to all three of said group consisting of said absolute value of said parameter being greater than or equal to said first threshold, said absolute value of said sample of said position error signal being greater than or equal to said second threshold, and said absolute value of said estimated next position error signal being greater than or equal to said third threshold.

15. A method performed by a controller in a hard disc drive to generate a write fault signal comprising:
receiving a sample of a position error signal;
generating a control signal from said position error signal;
capturing a sample of said control signal;
determining parameter from said sample of said control signal;
calculating an absolute value of said parameter;
comparing said absolute value of said parameter to a threshold value; and
generating a write fault error signal in response to a determination that said absolute value is greater than or equal to said threshold value.

16. The method of claim 15 wherein said step of determining said parameter comprises:
determining said control signal from said sample.

17. The method of claim 16 wherein said threshold is selected to improve write protection performance and not degrade throughput performance.

18. The method of claim 15 wherein said step for determining said parameter comprises:
determining a variation of said control signal from said sample of said control signal.

19. The method of claim 15 wherein said step of determining said variation comprises:
reading a previous sample of said control signal from a memory; and
calculating a difference of said sample of said previous control signal from said sample of said control signal.

20. The method of claim 19 wherein said step of determining said variation comprises:
storing said sample of said control signal as said previous control signal in said memory for use in a subsequent determination of said variation.

21. The method of claim 15 further comprising:
determining an absolute value of said sample of said position error signal;
comparing said absolute value of said sample of said position error signal with a second threshold; and
generating said write fault error in response to a determination that said absolute value of said sample of said position error signal is greater than or equal to said second threshold.

22. The method of claim 21 further comprising:
calculating a estimated next position error signal from said sample of said position error signal;
determining an absolute value of said next position error signal;
comparing said absolute value of said next position error signal with a third threshold; and
generating said write fault error in response to a determination that said absolute value of said next position error signal is greater than or equal to said third threshold.

23. The method of claim 22 wherein said step of calculating said next position error signal comprises:
determining said next position error signal from said sample of said position error signal and an average acceleration of said position error signal.

24. The method of claim 23 wherein said step of determining said next position error signal from said sample of said position error signal and an average acceleration of said position error signal comprises:
determining a velocity of said position error signal;
determining an average acceleration of said position error signal;
calculating said next position error signal in accordance with the following equation:
x̅(k+1)=x(k)+v(k)+1/2a(k)
where x̅(k+1) is the estimate next position error signal, x(k) is said position error signal, v(k) is said velocity, and a(k) is said average acceleration.

25. The method of claim 23 wherein said step of determining said next position error signal from said sample of said position error signal and an average acceleration of said position error signal comprise:
reading a sample of a previous position error signal from memory;
reading a sample of a second previous position error signal from said memory; and
calculating said estimated next position error signal from the following equation:
x̅(k+1)=5/2x(k)−2x(k−1)+1/2x(k−2)
where x̅(k+1) is said estimated next position error signal, x(k) is said sample of a previous position error signal, x(k−1) is said sample of a previous position error signal, and x(k−2) is said sample of a second previous position error signal.

26. The method of claim 24 further comprising:
generating said write fault signal in response to one selected from a group consisting of said absolute value of said parameter being greater than or equal to said first threshold, said absolute value of said sample of said position error signal being greater than or equal to said second threshold, and said absolute value of said estimated next position error signal being greater than or equal to said third threshold.

27. The method of claim 24 further comprising:
generating said write fault signal in response to two selected from a group consisting of said absolute value of said parameter being greater than or equal to said first threshold, said absolute value of said sample of said position error signal being greater than or equal to said second threshold, and said absolute value of said estimated next position error signal being greater than or equal to said third threshold.

28. The method of claim 22 further comprising:
generating said write fault signal in response to all three of said group consisting of said absolute value of said parameter being greater than or equal to said first threshold, said absolute value of said sample of said position error signal being greater than or equal to said second threshold, and said absolute value of said estimated next position error signal being greater than or equal to said third threshold.

29. A controller for a hard disk drive comprising:
circuitry configured to receive a sample of a position error signal;
circuitry configured to generate a control signal from said position error signal;
circuitry configured to capture a sample of said control signal;
circuitry configured to determine parameter from said sample of said control signal;
circuitry configured to calculate an absolute value of said parameter;
circuitry configured to compare said absolute value of said parameter to a threshold value; and
circuitry configured to generate a write fault error signal in response to a determination that said absolute value is greater than or equal to said threshold value.

30. The controller of claim 29 wherein said circuitry configured to determine said parameter comprises:
circuitry configured to determine said control signal from said sample.

31. The controller of claim 30 wherein said threshold is selected to improve write protection performance and not degrade throughput performance.

32. The controller of claim 29 wherein said circuitry configured to determine said parameter comprises:
circuitry configured to determine a variation of said control signal from said sample of said control signal.

33. The controller of claim 29 wherein said circuitry configured to determine said variation comprises:
circuitry configured to read a previous sample of said control signal from a memory; and
circuitry configured to calculate a difference of said sample of said previous control signal from said sample of said control signal.

34. The controller of claim 33 wherein said circuitry configured to determine said variation comprises:
circuitry configured to store said sample of said control signal as said previous control signal in said memory for use in a subsequent determination of said variation.

35. The controller of claim 29 further comprising:
circuitry configured to determine an absolute value of said sample of said position error signal;
circuitry configured to compare said absolute value of said sample of said position error signal with a second threshold; and
circuitry configured to generate said write fault error in response to a determination that said absolute value of said sample of said position error signal is greater than or equal to said second threshold.

36. The controller of claim 35 further comprising:
circuitry configured to calculate a estimated next position error signal from said sample of said position error signal;
circuitry configured to determine an absolute value of said next position error signal;
circuitry configured to compare said absolute value of said next position error signal with a third threshold, and
circuitry configured to generate said write fault error in response to a determination that said absolute value of said next position error signal is greater than or equal to said third threshold.

37. The controller of claim 36 wherein said circuitry configured to calculate said next position error signal comprises:
circuitry configured to determine said next position error signal from said sample of said position error signal and an average acceleration of said position error signal.

38. The controller of claim 37 wherein said circuitry configured to determine said next position error signal from said sample of said position error signal and an average acceleration of said position error signal comprise:
circuitry configured to determine a velocity of said position error signal;
circuitry configured to determine an average acceleration of said position error signal;
circuitry configured to calculate said next position error signal in accordance with the following equation:
x̅(k+1)=x(k)+v(k)+1/2a(k)
where x̅(k+1) is the estimate next position error signal, x(k) is said position error signal, v(k) is said velocity, and a(k) is said average acceleration.

39. The controller of claim 37 wherein said circuitry configured to determine said next position error signal from said sample of said position error signal and an average acceleration of said position error signal comprise:
circuitry configured to read a sample of a previous position error signal from memory;
circuitry configured to read a sample of a second previous position error signal from said memory; and
circuitry configured to calculate said estimated next position error signal from the following equation:
x̅(k+1)=5/2x(k)−2x(k−1)+1/2x(k−2)
where x̅(k+1) is said estimated next position error signal, x(k) is said sample of a previous position error signal, x(k−1) is said sample of a previous position error signal, and x(k−2) is said sample of a second previous position error signal.

40. The controller of claim 36 further comprising:
circuitry configured to generate said write fault signal in response to one selected from a group consisting of said absolute value of said parameter being greater than or equal to said first threshold, said absolute value of said sample of said position error signal being greater than or equal to said second threshold, and said absolute value of said estimated next position error signal being greater than or equal to said third threshold.

41. The controller of claim 36 further comprising:
circuitry configured to generate said write fault signal in response to two selected from a group consisting of said absolute value of said parameter being greater than or equal to said first threshold, said absolute value of said sample of said position error signal being greater than or equal to said second threshold, and said absolute value of said estimated next position error signal being greater than or equal to said third threshold.

42. The system of claim 36 wherein said instructions further comprise:
circuitry configured to generate said write fault signal in response to all three of said group consisting of said absolute value of said parameter being greater than or equal to said first threshold, said absolute value of said sample of said position error signal being greater than or equal to said second threshold, and said absolute value of said estimated next position error signal being greater than or equal to said third threshold.
